(19) United States
(12) Patent Application Publication
(10) Pub. No.: US 2002/0063349 A1
(43) Pub. Date: May 30, 2002

(54) Process for adding a surface finish to a fiber-reinforced composite

(76) Inventors: Christopher M. Edwards, Midland, MI (US); Edward L. D'Hooghe, Steensedijk (NL)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/000,734

(22) Filed: Oct. 31, 2001

Related U.S. Application Data
(60) Provisional application No. 60/245,620, filed on Nov. 6, 2000.

(51) Int. Cl. B29D 11/00; G02B 6/04

(52) U.S. Cl. 264/1.28; 385/115

(57) ABSTRACT

A method for creating surface modification onto a fiber-reinforced thermoplastic polyurethane composite is described. The method comprises the steps of a) drawing a fiber bundle through a heated thermoplastic polyurethane resin melt to impregnate the fiber bundle with the resin to form a wetted fiber bundle; b) wrapping a thermoplastic film over the wetted fiber bundle to provide surface modification over the wetted fiber bundle; and c) cooling and shaping the surface modified wetted fiber bundle to form the surface modified fiber reinforced composite. This method creates surface modification that imparts a variety of properties onto the surface including transparency, paintability, ignition resistance, scratch resistance, abrasion resistance, reflectiveness, and resistance to dust build-up.

### CROSS-REFERENCE STATEMENT

This application claims the benefit of U.S. Provisional Application No. 60/245,620 filed Nov. 6, 2000.

### BACKGROUND OF THE INVENTION

The present invention relates to a process for adding a surface finish to a fiber-reinforced composite. Surface finish is often added to a fiber-reinforced composite to render the composite smooth, soft, or UV-resistant. In a typical state of the art process, a layer of a non-woven polyester surfacing veil is wrapped around a continuous fiber bundle impregnated with a thermoset resin. The resin and any additives from the fiber bundle permeates through the veil, thereby forming a surface finish with resin that is the same as the resin from the composite.

Surface veils over thermoplastic composites, for example, polyolefinic veils wrapped around a continuous fiber reinforced polypropylene composite, are also known. Unfortunately, the limited compatibility of polypropylene with most thermoplastics limits the choice of veil material, thereby limiting the surface modification possibilities. Thus, if it is desired to create surfaces that are paintable, transparent, or ignition-, scratch- or abrasion resistant, another composite material with more versatile compatibility would be required.

### SUMMARY OF THE INVENTION

The present invention addresses a need in the art by providing a method for creating surface modification onto a fiber-reinforced engineering thermoplastic polyurethane composite comprising the steps of a) drawing a fiber bundle through a heated thermoplastic polyurethane resin melt to impregnate the fiber bundle with the resin to form a wetted fiber bundle; b) wrapping a thermoplastic film over the wetted fiber bundle to provide surface modification over the wetted fiber bundle; and c) cooling and shaping the surface modified wetted fiber bundle to form the surface modified fiber reinforced composite.

In a second embodiment, the present invention provides a method for creating surface modification onto a fiber-reinforced polar thermoplastic matrix composite comprising the steps of a) drawing a fiber bundle through a heated polar thermoplastic resin melt to impregnate the fiber bundle with the resin to form a wetted fiber bundle; b) wrapping a thermoplastic film over the wetted fiber bundle to provide surface modification over the wetted fiber bundle; and c) cooling and shaping the surface modified wetted fiber bundle to form the surface modified fiber reinforced composite; wherein the polar thermoplastic matrix is a polyester, a polyamide, or a thermoplastic polyurethane.

The method of the present invention provides surface finishing for a polyester, a polyamide, or a thermoplastic polyurethane (TPU) composite with a thermoplastic material. The finishing material can impart properties such as paintability, transparency, soft touch, and scratch-, abrasion- and ignition resistance to the surface. The finishing material may contain pigments or other particles that are desirable as surface modifiers, but undesirable as additives to the composite. As such, the present method offers a way of creating a variety of surface modifications without detrimentally affecting the fiber reinforcement in the composite.

### BRIEF DESCRIPTION OF THE DRAWINGS

FIG. 1 is a schematic of a preferred pultruder/extruder apparatus that is used to prepare a surface modified fiber-reinforced thermoplastic composite.

FIG. 2 is an exploded view of an impregnation unit and consolidation unit of the pultruder/extruder apparatus of FIG. 1.

FIG. 3 illustrates a view of thermoplastic film wrapping around the wetted fiber bundle.

### DETAILED DESCRIPTION OF THE INVENTION

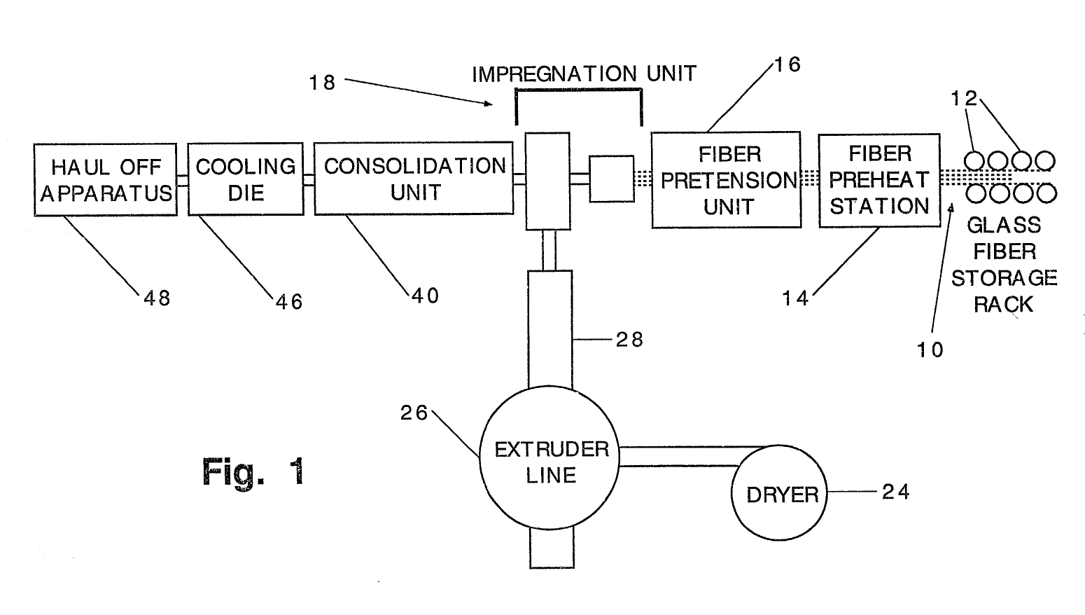

FIG. 1 illustrates a preferred apparatus for carrying out fiber bundle impregnation coupled with continuous surface modification to form a surface-modified fiber-reinforced polar resin matrix composite, preferably a TPU composite. FIG. 1 is a reproduction of the apparatus described in U.S. Pat. No. 5,891,560, incorporated herein by reference. Fiber bundle (10) from a fiber storage rack (12) is pulled through a fiber preheat station (14), which contains infrared ceramic heaters. Fiber bundle (10) may be composed of any of a number of different types of materials including glass, carbon, aramid fibers, ceramics, and various 5 metals. The preheat station is sufficiently hot to preheat the fibers to a temperature above the solidification point of the resin melt. The fiber bundle (10) is then pulled through a fiber pretension unit (16), which is an array of pins that spreads out the individual fibers and places them under tension, then pulled through an impregnation unit (18), where the fiber bundle is wetted with the resin melt.

The resin melt is preferably prepared in the following manner. Solid resin is granulated, then dried in a dehumidifier (24) to not more than 200 ppm water, more preferably not more than 100 ppm water. The dehumidified granulated resin is then advantageously extruded through a heated single screw extruder (26), which melts the resin by way of shear and heat. The resin melt is then transported by way of a heated resin channel (28) to the impregnation unit (18).

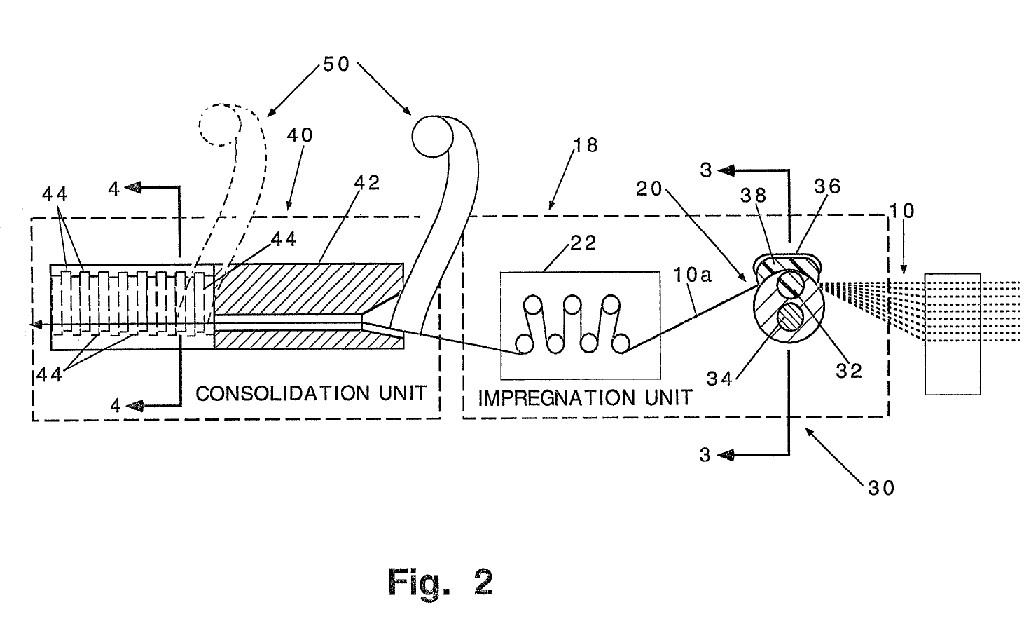

FIG. 2 represents a preferred embodiment of the impregnation unit (18) and the consolidation unit (40) coupled with the surface modifying unit (50). The impregnation unit (18) contains at least one impregnation pin (20) and a series of rods (22). The impregnation pin (20) comprises a substantially cylindrical member (30), which contains: a) two longitudinal channels, i) a first channel for resin melt transfer (32), and ii) a second channel for a cartridge heater (34), which keeps the impregnation pin (20) heated to a temperature above the melting point of the resin, or in the case of an engineering thermoplastic polyurethane (ETPU, also known as a rigid TPU), preferably in the range of about 200° C. to about 300° C.; and b) a slot formed by mounting an elongated member (36) above a longitudinal opening in the impregnation pin (20) coincident with the first channel (32). The longitudinal opening at the top of the impregnation pin (20) provides a means for the resin melt to contact the fiber bundle (10), which is being pulled through the slot in a substantially transverse direction to the flow of the resin melt through the first channel. The contact of the melt and the bundle are depicted as 38 in FIG. 2.

It is to be understood that the term “opening at the top” is used for convenience and is by not means intended to limit the design of the impregnation pin. Furthermore, the creation of a slot through which the fiber bundle (10) can pass and be contacted with resin can be done in a variety of ways, such as by milling a hollow cylinder lengthwise.

After the fiber bundle (10) is pulled through the slot of the impregnation pin (20) and wetted with the resin melt, the wetted fiber bundle (10a) is advantageously woven through a series of wet-out rods (22) to facilitate impregnation of resin. The impregnated fiber bundle (10a) is pulled through the consolidation unit (40), which contains a die (42), which initially shapes the fiber bundle (10a), and a plurality of wipe-off plates (44), which further shape the in the desired bundle (10a). A continuous sheet of a thermoplastic film (50) is overlayed onto and around the impregnated fiber bundle (10a) as the fiber bundle is pulled through the consolidation unit. The thermoplastic film may be overlayed at the front end of the consolidation unit (40) as shown by the solid line, or alternatively, overlayed proximal to the wipeoff plates (44), as shown by the dotted lines.

Referring again to FIG. 1, after the impregnated fiber bundle (10a) is pulled through the consolidation unit (40), the overlayed composite section is pulled through a cooling die (46), which solidifies the melt and provides a smooth surface. The cooling die (46) is designed to have the dimensions of the article to be formed. The completed overlayed article is preferably pulled by a caterpillar-type haul off machine (48).

The fibers, which are preferably aligned substantially parallel to each other and extend substantially through the length of the composite, constitute at least about 30 volume percent, preferably at least about 50 volume percent, and more preferably at least about 65 volume percent of the total volume of the fiber-reinforced composite article. The pultruded sections can be cut to any desired length, from millimeters to kilometers, and further shaped, formed, or joined using techniques well known in the art, including thermoforming, hot stamping, and welding.

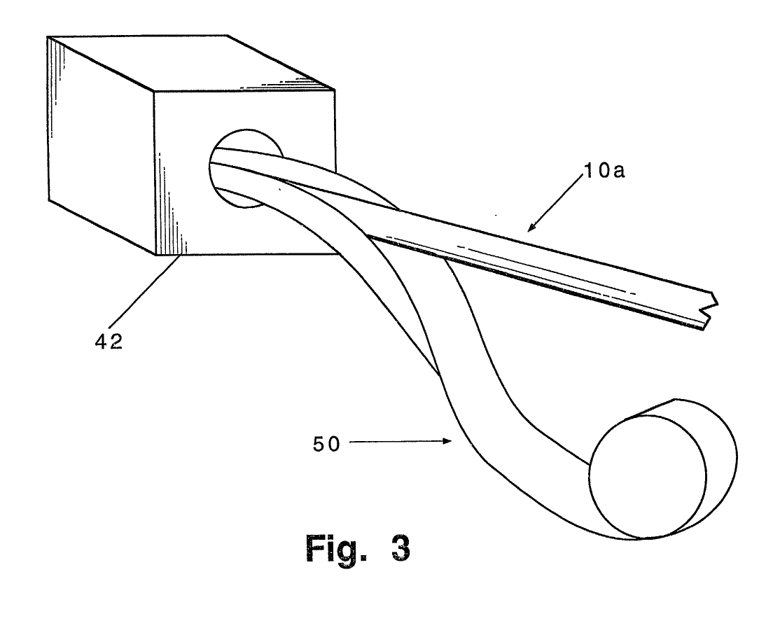

FIG. 3 illustrates a view of thermoplastic film (50) wrapping around the wetted fiber bundle (10a) as both are fed through the die (42). The heat of the wetted fiber bundle (10a) causes the thermoplastic film (50) to weld to the surface of the fiber bundle (10a) provided film (50) is compatible with the resin from the wetted fiber bundle (10a).

The TPU may be rigid or soft and is preferably rigid. Rigid TPUs (also known as engineering thermoplastic polyurethanes or ETPUs) are characterized by having a glass transition temperature of not less than 50° C. and preferably a hard segment content of at least 90 percent by weight, and most preferably 100 percent by weight. The disclosure and preparation of rigid thermoplastic polyurethanes (also known as engineering thermoplastic polyurethanes) is described, for example, by Goldwasser et al. in U.S. Pat. No. 4,376,834 and Oriani in U.S. Pat. No. 5,627,254, which teachings are incorporated herein by reference. ETPUs are commercially available under the tradename ISOPLAST™ ETPUs (a trademark of The Dow Chemical Company). Soft TPUs are characterized by having a Tg of less than 25° C. and a Shore A hardness of not more than 95 and are well known in the art. Soft TPUs are commercially available under the tradename PELLETHANE™ resins (a trademark of The Dow Chemical Company).

The nature of the surface veil used depends on the surface property desired. Acrylic, polycarbonate, ETPU, and styrene-acrylonitrile veils all impart transparency, which is useful for aesthetic reasons as well as for the practical application of placing nonremovable printed labels on the surface of the veil that contacts the composite. Polysulfone, polycarbonate, polyphenylene oxide, ETPU/polyphenylene oxide blends, and polyvinyl chloride veils all impart ignition resistance, which can be tuned with the addition of flame retardant compounds such as well known brominated compounds. An acrylic veil imparts scratch resistance and enhanced UV resistance; a soft TPU veil imparts soft touch and abrasion resistance; acrylic and TPU veils are also paintable, as are numerous other polymers. Woven or non-woven fabric such as TYVEKTM (a trademark of duPont de Nemours) non-woven fabric can be used as a veil to enhance off-axis properties, especially in thin sheets.

Additionally, conductive particles may be incorporated into the veil to prevent dust build-up; silicon oils and other lubricants may be incorporated to improve wear or abrasion resistance; magnetic media may be used to locally melt the resin in the presence of a magnetic field; and reflective particles such as glass may be used in combination with transparent veils to impart a reflective property in the composite.

The veil may also be multilayered (e.g., containing both ignition resistant and lubricating layers), colored, and multicolored.

What is claimed is:

1. A method for creating surface modification onto a fiber-reinforced thermoplastic polyurethane composite comprising the steps of a) drawing a fiber bundle through a heated thermoplastic polyurethane resin melt to impregnate the fiber bundle with the resin to form a wetted fiber bundle; b) wrapping a thermoplastic film over the wetted fiber bundle to provide surface modification over the wetted fiber bundle; and c) cooling and shaping the surface modified wetted fiber bundle to form the surface modified fiber reinforced composite.

2. The method of claim 1 wherein the thermoplastic polyurethane is an engineering thermoplastic polyurethane having a T_{g} of not less than 50° C.

3. The method of claim 1 wherein the thermoplastic polyurethane is a soft thermoplastic polyurethane having a T_{g} of less than 25° C.

4. The method of claim 2 wherein the thermoplastic film contains a thermoplastic other than a thermoplastic polyurethane.

5. The method of claim wherein the thermoplastic film is transparent.

6. The method of claim 1 wherein the thermoplastic film is ignition resistant.

7. The method of claim 1 wherein the thermoplastic film is abrasion or scratch resistant.

8. The method of claim 1 which wherein the thermoplastic film is paintable.

9. A method for creating surface modification onto a fiber-reinforced polar thermoplastic matrix composite comprising the steps of a) drawing a fiber bundle through a heated polar thermoplastic resin melt to impregnate the fiber bundle with the resin to form a wetted fiber bundle; b) wrapping a thermoplastic film over the wetted fiber bundle to provide surface modification over the wetted fiber bundle; and c) cooling and shaping the surface modified wetted fiber bundle to form the surface modified fiber reinforced composite; wherein the polar thermoplastic matrix is a polyester, a polyamide, or a thermoplastic polyurethane.
